(19) United States
(12) Patent Application Publication
(10) Pub. No.: US 2017/0261084 A1
(43) Pub. Date: Sep. 14, 2017

(54) ENHANCEMENTS TO HYDRO-MECHANICAL VEHICLE TRANSMISSION USING FIXED-DISPLACEMENT PUMP/MOTORS

(71) Applicant: Robert Hugh Francis LLOYD, Los Altos, CA (US)

(72) Inventor: Robert Hugh Francis LLOYD, Los Altos, CA (US)

(21) Appl. No.: 15/035,724

(22) PCT Filed: Oct. 24, 2014
(86) PCT No.: PCT/IB2014/002962

§ 371 Date: May 10, 2016

(51) Int. Cl. F16H 47/04; F16H 61/4157; F16H 61/4017; F16H 61/444; F16H 61/4096

(52) U.S. Cl. CPC F16H 47/04; F16H 61/444; F16H 61/4096; F16H 61/4017; F16H 61/4157; F16H 2047/045; F16H 2047/025

(57) ABSTRACT

Improvements to a hydro-mechanical transmission based on fixed displacement pump/motors rather than variable displacement pump/motors are disclosed. These include rpm-changing gears on the input and the output pump/motors which allow the pump/motors to be operated at their maximum rated rpm and facilitate compact packaging. A novel selectable clutch configuration is part of the packaging arrangement. The addition of a two-speed all mechanical transmission on the output extends the useful range of a mechanical bypass of the hydraulic transmission intended for cruising.

This PCT application claims the benefits of co-pending Non-Provisional application Ser. No. 14/086,503 filed Nov. 21, 2013 and entitled “Enhancements to High Efficiency Hydro-mechanical Vehicle Transmission” and Non-Provisional application Ser. No. 14/246,139 filed Apr. 6, 2014 and entitled “Selectable One-way and/or Dog clutch Assembly”.

### TECHNICAL FIELD

The present inventions relates to a hydro-mechanical truck, bus and passenger vehicle transmission which also facilitates the implementation of hydraulic regenerative braking.

### BACKGROUND ART

Throughout this application, the term pump/motor refers to hydraulic devices that can function either as a hydraulic pump or hydraulic motor with fluid flows in either direction.

Most present hydraulic and hydro-mechanical transmission intended for vehicles are based on variable displacement hydraulic pump/motors. None of them have been successfully applied to passenger cars due to problems associated with the variable displacement hydraulic pump/motors. These problems relate to efficiency, cost, form factor, noise and reliability.

### SUMMARY OF THE INVENTION

### Technical Problem

Most hydro mechanical vehicle transmissions are based on variable piston displacement hydraulic pump/motors.

Variable displacement hydraulic pump/motors have the following drawbacks:

1, The large number of moving parts contribute to;
A, relatively high friction losses which remain constant even when the displacement is low. The result is low efficiency at low displacements.
B, relatively high cost, low reliability, and high noise.

2, The irregular shape contributes to packaging problems.

### Solution to a Problem

Fixed displacement hydraulic pump/motors are inherently simpler than variable displacement devices and therefore avoid the problems of variable displacement devices. The transmission disclosed herein uses only fixed displacement pump/motors.

1, Although this transmission is intended to be used in conjunction with regenerative braking, under certain conditions (a full accumulator for example) the retarder function i.e. additional braking is desired (often used in truck and bus transmissions). This is performed by inserting a variable flow restrictor in one or more of the unselected pump/motors. The restriction of the flow provides the desired braking action.

2, Since it is desirable to be able to operate hydraulic pump/motors at their maximum rated rpm (for maximum power), the use of RPM-changing gears on both the output and input of the transmission is disclosed.

3, The gears of 2 above also allows the input and output pump/motors to be mechanically interleaved for improved packing density.

4, A novel design of a selectable one-way clutch and or a dog clutch allows the interleaving of 3 above. This clutch also allows all the hydraulic motors to participate in the initial acceleration of the vehicle, providing a high level of torque and also serves as an all mechanical bypass of the hydraulic transmission for improved efficiency when the vehicle is cruising. The dog clutch implements the direct drive desirable in some trucks and facilitates the use of regenerative braking while cruising. The later widens the useful speed range of the all-mechanical cruise gear.

5, The large number of pump/motors facilitated by this construction, allows for very small separation between the various “gears” which in turn allows the use of a very small accumulators to absorb the shifting shock. This also facilitates the use of the transmission as a conventional transmission (as a quasi-continuously variable transmission) without necessarily implementing regenerative braking.

6, An arrangement is disclosed where two adjacent pump/motors share a port to reduce the size of the combination allowing more power handling capability in the same physical volume and permitting the hydraulic interconnects in limited space.

7, The addition of a two or more speed all-mechanical transmission on the output or input of the transmission expands the high efficiency, all mechanical cruise range of the transmission.

8, The inclusion of the accumulator and the reservoir in the transmission case greatly simplifies the use of this transmission in existing vehicle designs and improves the safety by including all high pressure components in the protective transmission case.

### Advantageous Effects of the Invention

When compared to a transmission based on variable displacement devices, this transmission is more efficient, smaller, more reliable, lower cost, quieter, and more easily mounted in a limited space.

### BRIEF DESCRIPTION OF THE DRAWINGS

FIG. 1 illustrates the flow restricting valve used to accomplish the retarding function.

FIG. 2 illustrates the rpm changing gears on the input and output of the transmission.

FIG. 3 illustrates how the gearing allows the “interleaving” of the input and output pump/motors.

FIG. 4 illustrates the specialized selectable one-way clutch.

FIG. 5 illustrates two hydraulic pump/motors both with and without sharing a port.

FIG. 6 illustrates the small accumulators for pressure shock reduction and an all mechanical transmission on the output of the transmission.

FIG. 7 is a cross section of the transmission illustrating a selectable clutch that can be either a dog clutch or a one-way clutch.

FIG. 8 illustrates how the pump/motors are clustered together for compact packaging.

FIG. 9 illustrates how the shared pump/motor port allows compact packaging.

FIG. 10 illustrates how the accumulator and reservoir can be contained in the volume of a conventional transmission.

### DESCRIPTION OF THE PREFERRED EMBODIMENTS

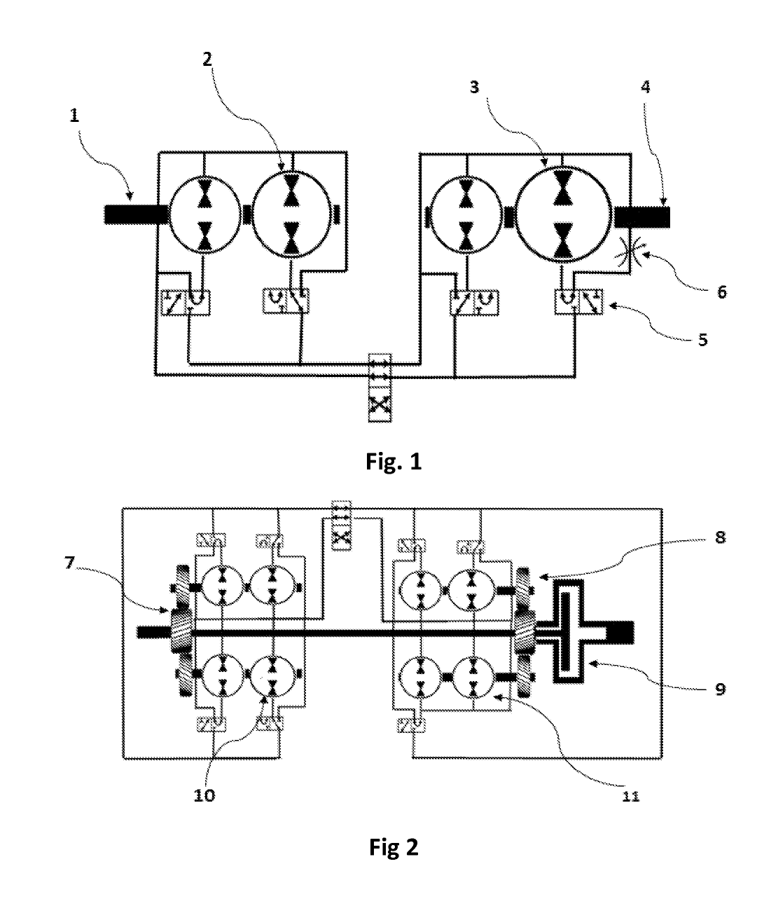

1 in FIG. 1 is the input shaft of a four pump/motor 2, 3 version of this transmission. Retarding or braking is accomplished by a valve 5 being positioned to cause the fluid in pump/motor 5 to recirculate. Closing flow restricting valve 6 will resist the turning motion of the output shaft 4 thereby applying a braking force to the vehicle.

FIG. 2 is a schematic of an 8 pump/motor version of this transmission illustrating the rpm-changing gears 7 & 8. 9 is a schematic representation of a selectable one-way and/or dog clutch whose purpose is, when engaged, to provide a mechanical by-pass of the transmission during cruising and to allow some or all of the input pump/motors 10 and some or all of the output pump/motors 11 to contribute to the acceleration of the vehicle when being powered by the accumulator (accumulator, reservoir and necessary valves not shown).

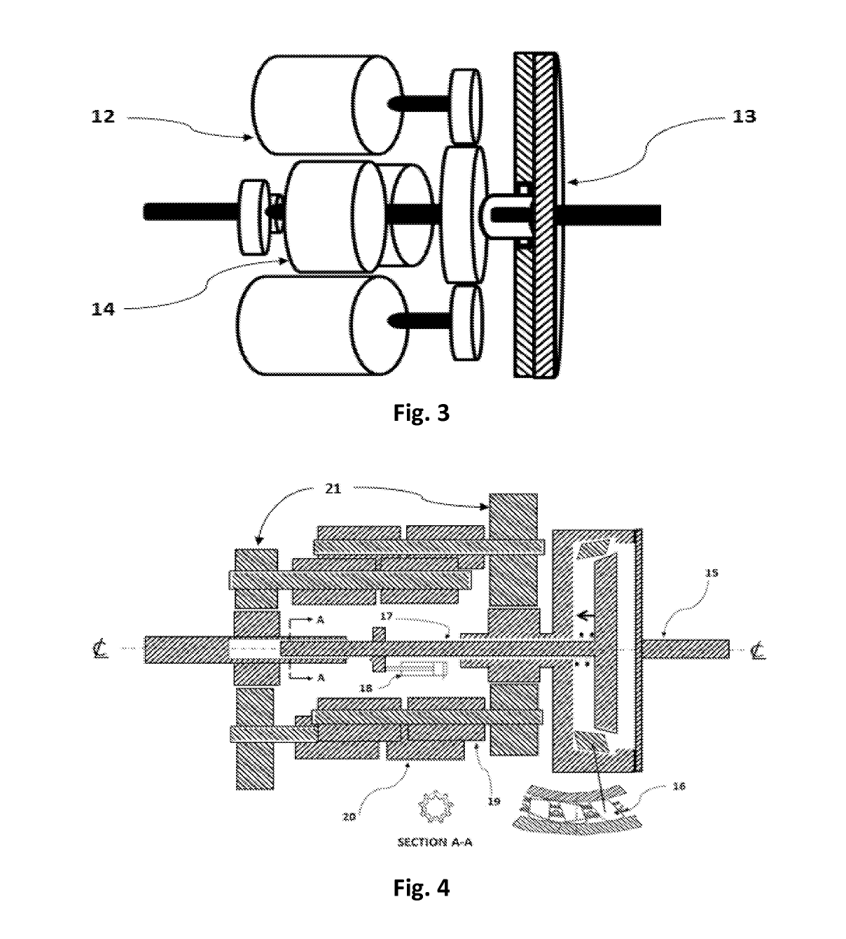

FIG. 3 illustrates how the clutch 13 allows the input pump/motors 14 to be “interleaved” with the output pump/motors 12 permitting a higher packing density.

FIG. 4 illustrates the details of how the selectable one-way sprag clutch 16 is arranged to allow the input pump/motors 20 to be “interleaved” with the output pump/motors 19. The input side of the clutch 17 is engaged with the output side 15 by actuator 18. 21 are the rpm-changing gears.

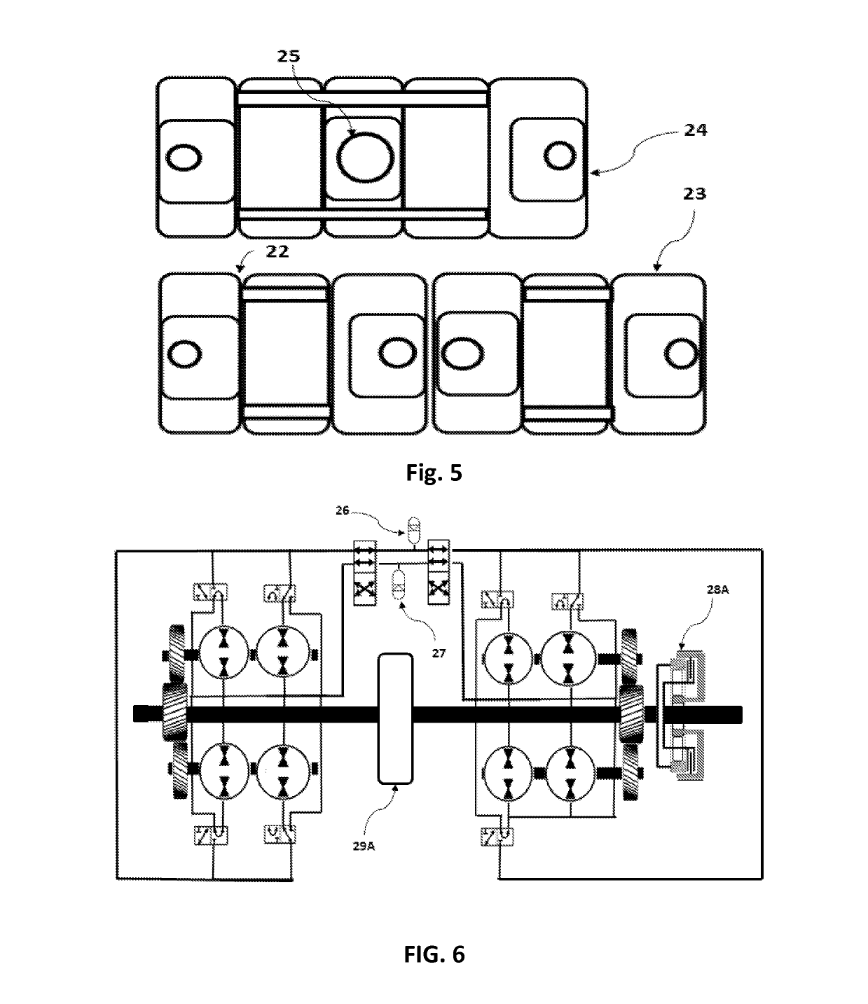

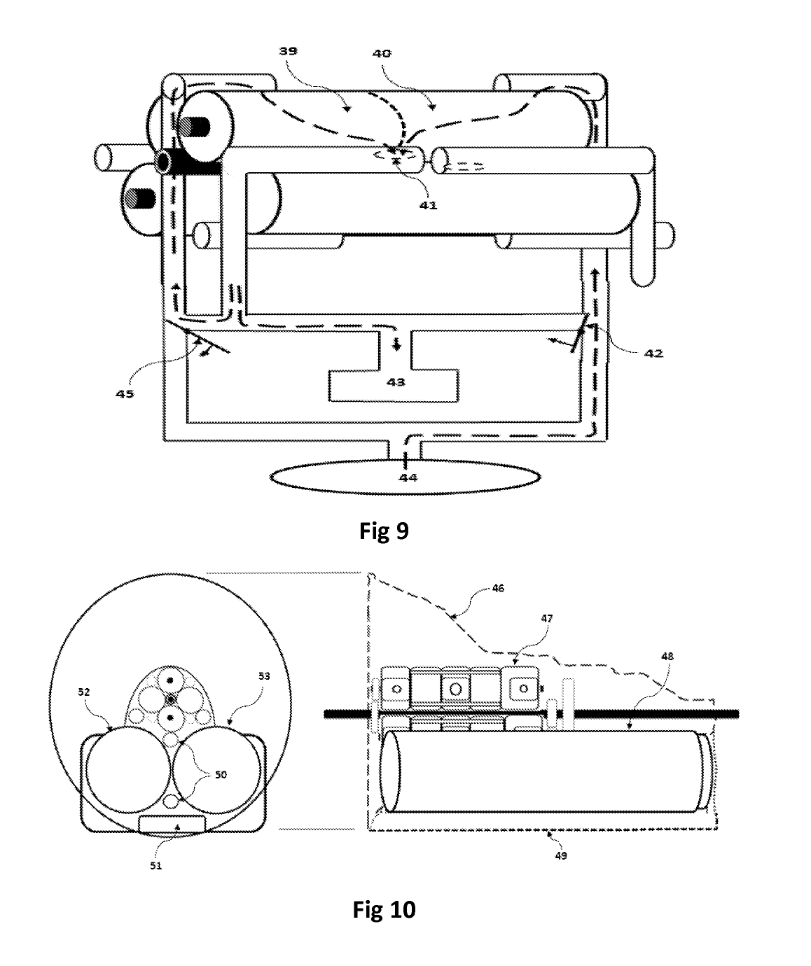

When two or more pump/motors are mounted on the same shaft, they can be constructed such as to share one port. This eliminates the need for one seal and bearing, thereby saving critical space and facilitates compact hydraulic fluid interconnects FIG. 9. FIG. 5 illustrates the space savings by comparing two separate pump/motors 22 & 23 with combined unit 24 sharing one port 25.

With a large number of pump/motors, the separations between the various “gears” can be made very small such that small always open accumulators, (26, 27 in FIG. 6), will suffice to absorb the pressure shock produced by rapid shifting under load. The accumulators would be arranged such that they could accept or deliver a small amount of fluid very rapidly. In a typical application, a full sized accumulator would be located next to small accumulator 26 and a reservoir next to small accumulator 27.

If a conventional all mechanical transmission 28A is added to the input or output of this transmission, a high efficiency multi-speed all mechanical path from input to output will exist when the clutch 29A is engaged.

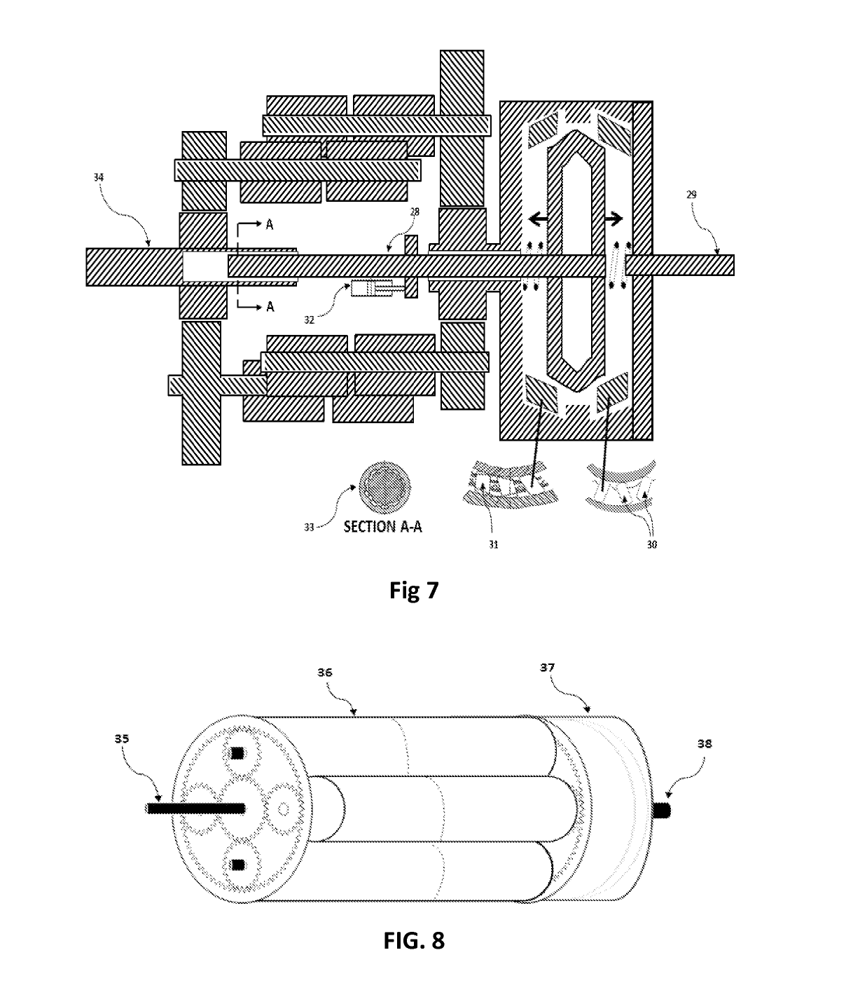

FIG. 7 illustrates a selectable sprag clutch that can be either one-way 31 or with a cone clutch or alternating apposing sprags 30, a dog clutch. Bi-directional actuator 32 causes the extension 28 of the input shaft 34 to cause the clutch to engage either as a dog clutch or a one-way clutch. The interface between the input shaft and its extension is splined 33.

FIG. 8 illustrates how the input 36 pump/motors and the output pump/motors are interleaved and connected by means of planetary rpm-changing gears to the input shaft 35 and output shaft 38 through the clutch 37.

FIG. 9 illustrates how the hydraulic connection would be made in a space-saving manner to common outflow port 41 of input pump/motors 39 & 40. Valves 42 & 45 are set in this illustration such that pump/motor 39 is in re-circulation mode and pump/motor 40 is selected such that the fluid flows from the accumulator 44 to the reservoir 44. In most applications of this transmission, there will be an accumulator to store energy and reservoir to store low pressure fluid, configured as in FIG. 9. The stored energy could come either from braking the vehicle (thereby implementing regenerative braking) or being pumped into the accumulator by the input shaft of the transmission (driven by an internal combustion engine for example).

FIG. 10 illustrates how the transmission 47 might fit in the outline 46 of a conventional transmission and the accumulator and reservoir 43 be accommodated by extending the bottom of the conventional transmission 49. Tanks 52 & 53 could be an accumulator and a reservoir or two accumulators, with the low pressure reservoir located external to the transmission case. 50 illustrates where the control valves might be located in a space saving manner. 51 indicates a possible position for an oil filter and cooler.

### INDUSTRIAL APPLICABILITY

This transmission is applicable to passenger cars, truck, buses and off-road vehicles as a means to implement regenerative braking and as a quasi-continuously variable transmission only.

### PATENT LITERATURE

U.S. Pat. No. 8,582,452 B2 dated Nov. 19, 2013 Titled “Infinitely Variable Hydro-Mechanical Transmission Using Fixed Displacement Pumps and Motors”

What is claimed is:

1, A hydraulic transmission consisting of:
a) one or more pump/motors attached to an input shaft;
b) one or more pump/motors attached to an output shaft;
c) a total of 3 pump/motors or more;
d) hydraulic flow paths and valves that allows some or all the pump/motors on the input shaft to pump fluid through some or all the pump/motors on the output shaft in either direction, or the output pump/motors to pump fluid through the input pump/motors in either direction;
e) a hydraulic valve associated with some or all of the pump/motors that can cause the hydraulic fluid to recirculate within the associated pump/motor such that it functions neither as a pump or a motor;
f) and an adjustable flow restricting device in the re-circulation fluid flow path of one or more of the pump/motors to serve as a brake on the associated shaft.

2, The transmission of claim 1 items a-e only, with
a) rpm-changing gears between the input shaft and the input pump/motors; and
b) rpm-changing gears between the output shaft and the output pump/motors.

3, The transmission of claim 1 items a-e only, where the input and out shafts are inline and the input and output pump/motors are located on the adjacent sides of the rpm-changing gears in a manner that allows the input and output pump/motors to be located adjacent to each other in the same volume without the rpm-changing gears between them.

4, The transmission of claim 3 wherein:
a) the input shaft is in line with the output shaft and extended concentrically through the output shaft to a point beyond the output rpm-changing gears;
b) the portion of the input shaft that is extended through the output shaft is such that it can vary the length of the input shaft;
c) the end of the input shaft that is beyond the output rpm-changing gear is attached to one side of a clutch that can be either a one-way clutch and/or a dog clutch;
d) the other side of the clutch in c directly above, is such that it connects to the output shaft that connects to the output rpm-changing gear and also becomes the output shaft of the transmission; and
e) with a means to move the extension of the input shaft in such a manner that it causes the clutch to engage and dis-engage.

5, The transmission in claim 4 except the clutch is located on the input end of the transmission and connected to the input shaft not the output shaft in a similar manner as in claim 4.

6, The transmission in claims 4 and 5, where an all-mechanical, multispeed transmission is located as an extension of the input shaft or output shaft or both.

7, The transmission in claims 4 and 5, where the valves are arranged such that with the clutch engaged, some or all of the input pump/motors and some or all of the output pump/motors can serve as motors being powered by the high pressure fluid from an accumulator; to provide the maximum range of output torque.

8, The transmission in claim 1 a-e only, where an accumulator is located in the same physical case as the transmission.

9, The transmission of claim 1 items a-e only, with two or more pump/motors on the same shaft where adjacent pump/motors are constructed such that they can share an input or output port and thereby reduce the combined size.

10, The transmission of claim 1 items a-e only, where small accumulators are attached to both the high pressure line and the low pressure line or just the high pressure line of the hydraulic flow path for the purposes of absorbing fluid pressure spikes.

11, The transmission of claim 4 wherein planetary rpm-changing gears are used to allow 4 or more total pump/motors to achieve a large numbers of transmission input to output rpm ratios.
